(19) United States
(12) Patent Application Publication
(10) Pub. No.: US 2014/0274383 A1
(43) Pub. Date: Sep. 18, 2014

(54) Method For Playing a Game Using Generic On-Line Chat Conversation, From An Opponent, As Game Data

(71) Applicant: Blot Interactive Inc., Toronto (CA)

(72) Inventors: Justin Kwok, Toronto (CA); Neil Malcolm McMechan Inglis, Toronto (CA); Norma Diane Rossler, Cambridge (CA); Brandon Christopher Randall Hicks, Toronto (CA); Alvin Idmilao Aquino, Markham (CA); Duarte Faria, Toronto (CA); Shannon Michelle Conrad, Toronto (CA)

(73) Assignee: Blot Interactive Inc., Toronto (CA)

(21) Appl. No.: 14/212,540

(22) Filed: Mar. 14, 2014

Related U.S. Application Data
(60) Provisional application No. 61/783,690, filed on Mar. 14, 2013.

(51) Int. Cl. A63F 13/30

(52) U.S. Cl. CPC A63F 13/12
USPC 463/31

(57) ABSTRACT

A method and system are provided for playing a game on-line using ordinary chat messages. A list of words is presented by an automated process running the game and presented to a player, and the player selects one of the words. The automated process also displays forbidden words to the player, which are words that the player may not use in outgoing chat messages. Chat messages are exchanged with another person who is using a standard chat messaging service and the automated process parses the content of the chat messages. If the word selected by the player is present in an incoming chat message, the player wins. If the selected word or if any forbidden words associated with the selected word is present in an outgoing chat message, the player loses.

### FIELD OF INVENTION

This invention relates to computer gaming, and in particular to using on-line chat messages in computer gaming.

### BACKGROUND

There is a desire amongst many people for entertainment. As people interact more frequently over social media, opportunity exists to combine remote interaction over the internet with entertainment.

### SUMMARY

According to one aspect, a method is provided for playing a game on-line. Upon initiation of the game by a player, a game chat client displays a list of eligible words to the player and at least two words associated with each eligible word. The game chat client receives a selection made by the player of one of the eligible words, designating this selected eligible word as a target word and the words associated with this selected eligible word as forbidden words. The game chat client monitors chat messages from the player to a non-player, the non-player sending and receiving the chat messages through a standard chat message service, for the presence of the target word or of any of the forbidden words. The game chat client also monitors chat messages from the non-player to the player, for the presence of the target word. If the target word or any of the forbidden words is present in a chat message from the player to the non-player, the game chat client indicates to the player that the game is lost. If the target word is present in a chat message from the non-player to the player, the game chat client indicates to the player that the game is won.

In one embodiment, the game chat client displaying a difficulty level in association with each eligible word. A number of points is awarded to the player if the game is won, the number of points awarded being dependent on the difficulty level of the target word.

The methods of embodiments of the invention may be stored as logical instructions on a non-transitory computer-readable storage medium in a form executable by a computer processor.

By parsing chat messages, people can play a game while conversing with others remotely, or can participate in a game with a remote acquaintance with or without the acquaintance's knowledge.

### BRIEF DESCRIPTION OF THE DRAWINGS

The features and advantages of embodiments of the invention will become more apparent from the following detailed description of the preferred embodiment(s) with reference to the attached figures, wherein:

FIG. 1 shows a network in which two people interact by exchanging chat messages according to one embodiment of the invention; and

FIG. 2 shows a flowchart of a method executed by the game chat client of FIG. 1 according to one embodiment of the invention.

It is noted that in the attached figures, like features bear similar labels.

### DETAILED DESCRIPTION OF THE PREFERRED EMBODIMENTS

Referring to FIG. 1, a network in which two people interact by exchanging chat messages according to one embodiment of the invention is shown. A player 10 is in chat communication with a non-player 12. Chat messages from the player 10 to the non-player 12 pass through a game chat client 14, over the Internet 16 to a third-party chat server 18, such as a Facebook xmpp server, over the Internet 16 to a second chat client 22, and then to the non-player 12. The second chat client 22 may be any standard chat message client used by the non-player 12 to exchange chat messages with others, such as Facebook messenger, Skype messenger, and Yahoo messenger.

The non-player 12 may or may not be aware that the player 10 is playing a game. The terms “player” and “non-player” are used herein because it is the player 10 who operates the game chat client 14, such as by initiating a game or being informed of eligible target words. The non-player 12 may or may not be aware of the game.

Broadly, upon initiation of a game by a player, the game chat client 14 selects eligible words and displays the eligible words to the player 10. The player 10 selects one of the eligible words as the target word, and is informed of forbidden words. Thereafter the game chat client 14 monitors chat messages exchanged between the player 10 and the non-player 12 for the presence of the target word or of any of the forbidden words. If the target word or any of the forbidden words is present in a chat message from the player 10 to the non-player 12, the game chat client 14 indicates to the player 10 that the game is lost. If the target word is present in a chat message from the non-player 12 to the player 10, then the game chat client 14 indicates to the player 10 that the game is won.

It should be noted that the methods are described herein with reference to a game. More generally the methods described herein may apply to a round within a game, the methods being repeated for each round of the game. For simplicity, the term “game” is used throughout but is intended to also include a round in a larger game.

Referring to FIG. 2, a flowchart of a method executed by the game chat client 14 of FIG. 1 according to one embodiment of the invention is shown. The method begins when the player 10 chooses to start a game. At step 40 the game chat client 14 selects a number of eligible words from amongst a list of possible words and presents them to the player 10. Along with the eligible words the game chat client 14 also presents associated with each eligible word two or more words that the player 10 may not use if that eligible word is selected. In one embodiment, the presentation of the eligible words also includes presentation of a difficulty level for each of the eligible words. The eligible words are preferably words that are sometimes used in every day speech, such as “robot” or “sandwich”, as are the words that cannot be used. At step 42 to the game chat client 14 receives a selection of one of the eligible words made by the player 10. This selected word becomes the target word, and the words associated with this word that the player cannot use become the forbidden words. From then on, chat messages are exchanged between the player 10 and the non-player 12. At step 44 the game chat client 14 waits to be made aware of chat messages.

One possibility of ending the waiting at step 44 is that the game chat client 14 becomes aware of an outgoing chat message (i.e. from the player 10 to the non-player 12), illustrated in FIG. 2 as event 46. At step 48 the game chat client 14 performs an expression check on the text content of the outgoing message. At step 50 the game chat client 14 determines whether the target word or any of the forbidden words is present in the text content of the outgoing message. If the target word and all of the forbidden words are not present then the game chat client 14 simply returns to waiting for the next chat message. However if the game chat client 14 determines that the target word or any of the forbidden words is present in the text content of the chat message, then at step 52 the game chat client 14 indicates to the player 10 that the game has been lost because the player 10 has used the target word or one of the forbidden words in a chat message directed to the non-player 12.

Another possibility of ending the waiting at step 44 is that the game chat client 14 becomes aware of an incoming chat message (i.e. from the non-player 12 to the player 10), illustrated in FIG. 2 as event 60. At step 62 the game chat client 14 performs an expression check on the text content of the incoming message. At step 64 the game chat client 14 determines whether the target word is present in the text content of the incoming message. If the target word is not present then the game chat client 14 simply returns to waiting for the next chat message at step 44. However if the game chat client 14 determines that the target word is present in the text content of the chat message, then at step 66 the game chat client 14 indicates to the player 10 that the game has been won because the non-player 12 has used the target word in a chat message directed to the player 10.

At step 68 the game chat client 14 triggers one or more events that result from the player 10 winning the game. For example, the game chat client 14 can increase the number of points available to the player 10, the points usable to cosmetically change an avatar used by the player 10, to obtain word lists, and/or to obtain a new scene in which the player's avatar exists. These points may be stored in computer memory accessible to the game chat client 14. In the embodiment in which a difficulty level is also displayed with the eligible words, the number of points that are increased may be related to the difficulty level associated with the target word, more points being awarded for words of a higher difficulty level. As another example, the game chat client 14 may cause the avatar of the player 10 to perform some action. A yet another example, the game chat client 14 may launch a mini-game which the player 10 can play.

In the embodiments described above, the game chat client 14 triggers one or more events upon the player 10 winning the game. In an alternative embodiment this step is omitted. The game chat client 14 simply indicates to the player 10 that he or she has won the game or round. The player's “reward” for winning is simply a sense of satisfaction and/or bragging rights.

The embodiments presented are exemplary only and persons skilled in the art would appreciate that variations to the embodiments described above may be made without departing from the spirit of the invention. For example, the steps of expression checking a chat message and determining whether a target word is present may be combined, i.e. performing the expression checking as part of the determination of the presence of the target word. The scope of the invention is solely defined by the appended claims.

I/we claim:

1. A method comprising:
upon initiation of a game by a player, a game chat client displaying a list of eligible words to the player and at least two words associated with each eligible word;
receiving by the game chat client a selection made by the player of one of the eligible words, designating this selected eligible word as a target word and the words associated with this selected eligible word as forbidden words;
monitoring by the game chat client chat messages from the player to a non-player, the non-player sending and receiving the chat messages through a standard chat message service, for the presence of the target word or of any of the forbidden words;
monitoring by the game chat client chat messages from the non-player to the player, for the presence of the target word;
if the target word or any of the forbidden words is present in a chat message from the player to the non-player, indicating to the player by the game chat client that the game is lost; and
if the target word is present in a chat message from the non-player to the player, indicating to the player by the game chat client that the game is won.

2. The method of claim 1 further comprising:
triggering by the game chat client at least one event if the game is won.

3. The method of claim 2 wherein the at least one event includes increasing a number of points available to the player.

4. The method of claim 2 wherein the at least one event includes causing an avatar of the player to perform some action.

5. The method of claim 1 further comprising:
displaying, by the game chat client, a difficulty level in association with each eligible word.

6. The method of claim 3 further comprising displaying, by the game chat client, a difficulty level in association with each eligible word, and wherein the number of points by which the available number of points is increased is dependent on the difficulty level of the target word.

7. A non-transitory computer-readable medium comprising instructions executable by a computer processor, the instructions comprising instructions to:
upon initiation of a game by a player, display on a game chat client a list of eligible words to the player and at least two words associated with each eligible word;
receive by the game chat client a selection made by the player of one of the eligible words, designating this selected eligible word as a target word and the words associated with this selected eligible word as forbidden words;
monitor by the game chat client chat messages from the player to a non-player, the non-player sending and receiving the chat messages through a standard chat message service, for the presence of the target word or of any of the forbidden words;
monitor by the game chat client chat messages from the non-player to the player, for the presence of the target word;
if the target word or any of the forbidden words is present in a chat message from the player to the non-player, indicate to the player by the game chat client that the game is lost; and
if the target word is present in a chat message from the non-player to the player, indicate to the player by the game chat client that the game is won.

8. The non-transitory computer-readable medium of claim 7 further comprising instructions to trigger, by the game chat client, at least one event if the game is won.

9. The non-transitory computer-readable medium of claim 8 wherein the at least one event includes increasing a number of points available to the player.

10. The non-transitory computer-readable medium of claim 8 wherein the at least one event includes causing an avatar of the player to perform some action.

11. The non-transitory computer-readable medium of claim 7 further comprising:
instructions to display, by the game chat client, a difficulty level in association with each eligible word.

12. The non-transitory computer-readable medium of claim 9 further comprising instructions to display, by the game chat client, a difficulty level in association with each eligible word, and wherein the number of points by which the available number of points is increased is dependent on the difficulty level of the target word.
